(19) United States
(12) Patent Application Publication
(10) Pub. No.: US 2022/0295134 A1
(43) Pub. Date: Sep. 15, 2022

(54) DYNAMICALLY USING INTERNET OF THINGS DEVICES TO CONTROL PLAYBACK OF MULTIMEDIA

(71) Applicant: International Business Machines Corporation, Armonk, NY (US)

(72) Inventors: Manish Anand Bhide, Hyderabad (IN); Madan K Chukka, Hyderabad (IN); Phani Kumar V. U. Ayyagari, Hyderabad (IN); PurnaChandra Rao Jasti, Hyderabad (IN)

(21) Appl. No.: 17/200,874

(22) Filed: Mar. 14, 2021

(51) Int. Cl. H04N 21/2743; H04N 21/472; H04N 21/2187; G16Y 10/75; H04N 21/262; H04N 21/4223; H04N 21/414

(52) U.S. Cl. CPC H04N 21/2743; H04N 21/47217; H04N 21/2187; G16Y 10/75; H04N 21/262; H04N 21/4223; H04N 21/41407

(57) ABSTRACT

Aspects of the present invention disclose a method for performing playback functions of a multimedia feed based on a task of a request and an activity of a user. The method includes one or more processors identifying a task of multimedia of a video sharing application of a computing device. The method further includes determining an activity of a user utilizing a live video feed of a camera of the computing device. The method further includes determining whether the activity of the user correlates to the task of the multimedia. The method further includes in response to determining that the activity of the user correlates to the task of the multimedia, initiating a playback function of the video sharing application of the computing device based at least in part on the activity of the user and the task of the multimedia.

### BACKGROUND OF THE INVENTION

The present invention relates generally to the field of internet of things, and more particularly to orchestrating internet of things enabled devices utilizing tasks of a request.

In recent years, developments and the growth of Internet of Things (IoT) capable devices have created a wealth of opportunities to advance the capabilities to integrate systems. The internet of things (IoT) is the internetworking of physical devices (also referred to as “connected devices” and “smart devices”), vehicles, buildings, and other items, embedded with electronics, software, sensors, actuators, and network connectivity that enable these objects to collect and exchange data. The IoT allows objects to be sensed and/or controlled remotely across existing network infrastructure, creating opportunities for more direct integration of the physical world into computer-based systems, and resulting in improved efficiency, accuracy, and economic benefit in addition to reduced human intervention. Each thing is uniquely identifiable through its embedded computing system but is able to interoperate within the existing Internet infrastructure.

Cognitive analytics combines the use of cognitive computing and analytics. Cognitive computing combines artificial intelligence and machine-learning algorithms, in an approach that attempts to reproduce the behavior of the human brain. Analytics is the scientific process of transforming data into insights for making better decisions. Cognitive analytics applies intelligent technologies to bring unstructured data sources within reach of analytics processes for decision making and improved functions. In particular, natural language processing (NLP), which is a sub-field of computer science that enables a computer to process and analyze large amounts of natural language data.

### SUMMARY

Aspects of the present invention disclose a method, computer program product, and system for performing playback functions of a multimedia feed based on a task of a request and an activity of a user. The method includes one or more processors identifying a task of multimedia of a video sharing application of a computing device. The method further includes one or more processors determining an activity of a user utilizing a live video feed of a camera of the computing device. The method further includes one or more processors determining whether the activity of the user correlates to the task of the multimedia. The method further includes in response to determining that the activity of the user correlates to the task of the multimedia, one or more processors initiating a playback function of the video sharing application of the computing device based at least in part on the activity of the user and the task of the multimedia.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program, within the data processing environment of FIG. 1, for performing playback functions of a multimedia feed based on a task of a request and an activity of a user, in accordance with embodiments of the present invention.

FIG. 3 is a block diagram of components of FIG. 1, in accordance with an embodiment of the present invention.

### DETAILED DESCRIPTION

Embodiments of the present invention allow for performing playback functions of a multimedia feed based on a task of a request and an activity of a user. Embodiments of the present invention correlate task of a request of multimedia feed with a current user activity and perform playback functions of a video sharing application based on the current user activity. Additional embodiments of the present invention schedule tasks corresponding a request for one or more internet of things (IoT) enabled devices based on multimedia content. Further embodiments of the present invention generate a protocol to represent IoT devices utilized in performing a task of a request.

Some embodiments of the present invention recognize that synchronization challenges exist with users performing tasks along with instructions delivered via multimedia. Additionally, synchronization challenges are furthered when the tasks require the utilization and coordination of a plurality of IoT devices. For example, for a user following instructions corresponding to a task of a video (e.g., multimedia) the user is required to manually initiate playback functions (e.g., play, pause, rewind, fast forward, etc.) of the video constantly due to the video playing at a higher rate than the user can practically perform the instructions corresponding to the task. Embodiments of the present invention propose to eliminate manual initiation controlling playback functions based on video data that includes a current user activity regarding the task of the multimedia. Additionally, embodiments of the present invention eliminate coordination tasks by automatically providing settings and instructions corresponding to tasks assigned to the plurality of IoT devices to be utilized to complete tasks.

Embodiments of the present invention can operate to reduce power consumption of a computing system (e.g., smart building) by powering off or activating a sleep mode of IoT devices with no pending tasks or that are not required in the performance of tasks of a request. Additionally, embodiments of the present invention advance IoT platforms by providing an intelligent orchestration mechanism that automates functions of one or more IoT devices associated with an IoT platform in real-time. As a result, allowing any new IoT device that adheres to the new protocol can be integrated into the framework easily.

Implementation of embodiments of the invention may take a variety of forms, and exemplary implementation details are discussed subsequently with reference to the Figures.

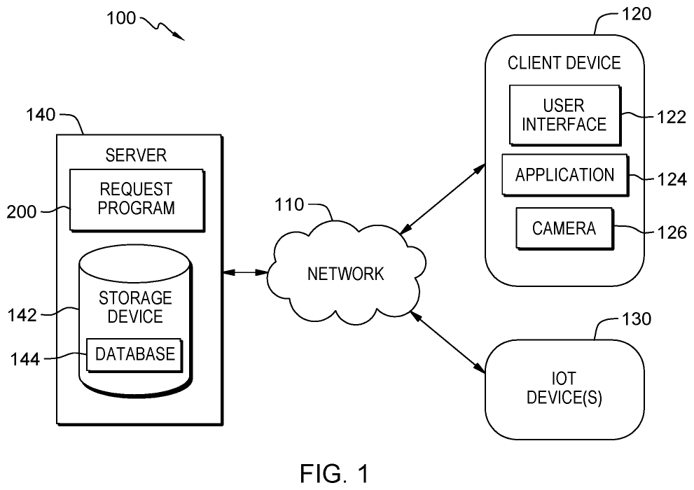

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

The present invention may contain various accessible data sources, such as storage device 142, database 144, application 124, and/or camera 126, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Request program 200 enables the authorized and secure processing of personal data. Request program 200 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Request program 200 provides information regarding personal data and the nature (e.g., type, scope, purpose, duration, etc.) of the processing. Request program 200 provides the user with copies of stored personal data. Request program 200 allows the correction or completion of incorrect or incomplete personal data. Request program 200 allows the immediate deletion of personal data.

Distributed data processing environment 100 includes server 140, IoT device(s) 130, and client device 120, all interconnected over network 110. Network 110 can be, for example, a telecommunications network, a local area network (LAN) a municipal area network (MAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include voice, data, and video information. In general, network 110 can be any combination of connections and protocols that will support communications between server 140, IoT device(s) 130, and client device 120, and other computing devices (not shown) within distributed data processing environment 100.

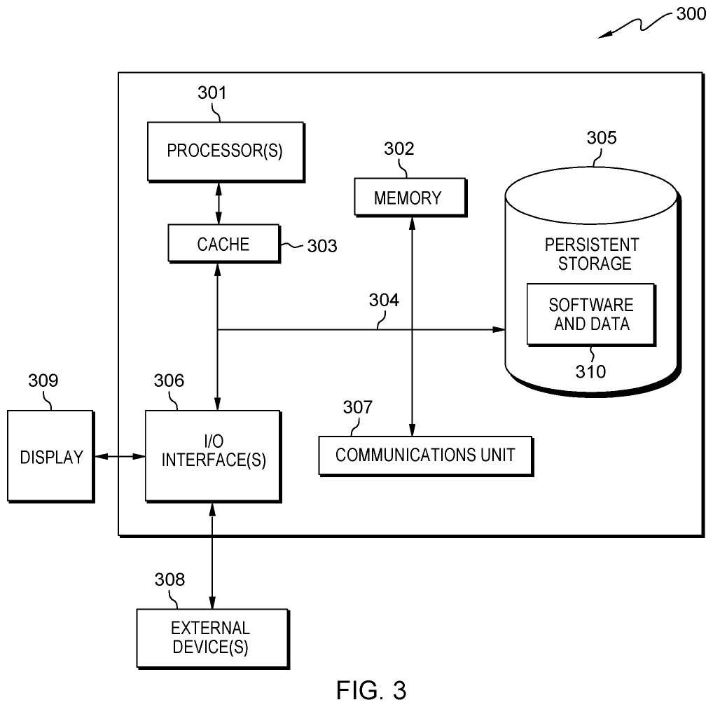

Client device 120 can be one or more of a laptop computer, a tablet computer, a smart phone, smart watch, a smart speaker, virtual assistant, chimney hob, or any programmable electronic device capable of communicating with various components and devices within distributed data processing environment 100, via network 110. In general, client device 120 represents one or more programmable electronic devices or combination of programmable electronic devices capable of executing machine readable program instructions and communicating with other computing devices (not shown) within distributed data processing environment 100 via a network, such as network 110. Client device 120 may include components as depicted and described in further detail with respect to FIG. 3, in accordance with embodiments of the present invention.

Client device 120 includes user interface 122, application 124, and camera 126. In various embodiments of the present invention, a user interface is a program that provides an interface between a user of a device and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122 is a script or application programming interface (API).

Application 124 is a computer program designed to run on client device 120. An application frequently serves to provide a user with similar services accessed on personal computers (e.g., web browser, playing music, e-mail program, or other media, etc.). In one embodiment, application 124 is mobile application software. For example, mobile application software, or an “app,” is a computer program designed to run on smart phones, tablet computers and other mobile devices. In another example, application 124 is a video sharing application. In this example, request program 200 utilizes the video sharing application to display multimedia that includes one or more tasks to a user. In another embodiment, application 124 is a web user interface (WUI) and can display text, documents, web browser windows, user options, application interfaces, and instructions for operation, and include the information (such as graphic, text, and sound) that a program presents to a user and the control sequences the user employs to control the program. In another embodiment, application 124 is a client-side application of request program 200.

Camera 126 is a machine vision system which, in addition to image capture circuitry, is capable of extracting application-specific information from the captured images, along with generating event descriptions or making decisions that are used in an intelligent and automated system. In one embodiment, camera 126 is a smart camera that is a self-contained, standalone vision system with built-in image sensor in a housing of an industrial video camera, which contains all necessary communication interfaces. For example, request program 200 utilizes a data feed (e.g., video data) of camera 126 to monitor and/or identify current user activities performed within the field of view of camera 126.

IoT device(s) 130 can include one or more of a laptop computer, a tablet computer, a smart phone, smart watch, a smart speaker, virtual assistant, kitchen appliance, sensor, or any programmable electronic device capable of communicating with various components and devices within distributed data processing environment 100, via network 110. In general, IoT device(s) 130 represents one or more programmable electronic devices or combination of programmable electronic devices capable of executing machine readable program instructions and communicating with other computing devices (not shown) within distributed data processing environment 100 via a network, such as network 110. For example, IoT device(s) 130 can include wireless sensors, software, actuators, and/or computer devices that are attached to a particular object (e.g., chimney hob) that operates through the internet, enabling the transfer of data among objects or people automatically without human intervention. IoT device(s) 130 may include components as depicted and described in further detail with respect to FIG. 3, in accordance with embodiments of the present invention.

Server 140 can be a standalone computing device, a management server, a web server, a mobile computing device, or any other electronic device or computing system capable of receiving, sending, and processing data. In one embodiment, server 140 can represent a server computing system utilizing multiple computers as a server system, such as in a cloud computing environment. In another embodiment, server 140 can be a laptop computer, a tablet computer, a netbook computer, a personal computer (PC), a desktop computer, a personal digital assistant (PDA), a smart phone, or any programmable electronic device capable of communicating with client device 120 and other computing devices (not shown) within distributed data processing environment 100 via network 110. In another embodiment, server 140 represents a computing system utilizing clustered computers and components (e.g., database server computers, application server computers, etc.) that act as a single pool of seamless resources when accessed within distributed data processing environment 100.

Server 140 includes storage device 142, database 144, and request program 200. Storage device 142 can be implemented with any type of storage device, for example, persistent storage 305, which is capable of storing data that may be accessed and utilized by client device 120, IoT device(s) 130, and server 140, such as a database server, a hard disk drive, or a flash memory. In one embodiment storage device 142 can represent multiple storage devices within server 140. In various embodiments of the present invention, storage device 142 stores numerous types of data which may include database 144. Database 144 may represent one or more organized collections of data stored and accessed from server 140. For example, database 144 includes a request, task of request, user activities, protocols, generated instructions, etc. In one embodiment, data processing environment 100 can include additional servers (not shown) that host additional information that accessible via network 110.

Generally, request program 200 can perform playback functions of a multimedia feed based on a task of a request and a current user activity. In one embodiment, request program 200 correlates a task of a request of multimedia running on application 124 with a current user activity of video data of camera 126. Additionally, request program 200 determines a playback function of application 124 to perform based on the current user activity and the task. Also, request program 200 schedules tasks corresponding one or more requests for one or more instances of IoT device(s) 130 based on tasks of the multimedia content of application 124 (i.e., determine which tasks can be performed in parallel with respect to IoT devices). Furthermore, request program 200 generates a protocol to one or more instances of IoT device(s) 130 utilized in performing the tasks of the request. For example, request program 200 provides cooking assistance to a user by utilizing a smart chimney (e.g., client device 120) with IoT sensors (e.g., IoT device(s) 130) and AI camera (e.g., camera 126). In this example, request program 200 utilizes a client-side application (e.g., application 124) of the smart chimney to analyze and compare live (real-time) cooking process (e.g., current user activity) of the user with a live video stream content (e.g., database 144) from a video sharing application (e.g., application 124) of the smart chimney.

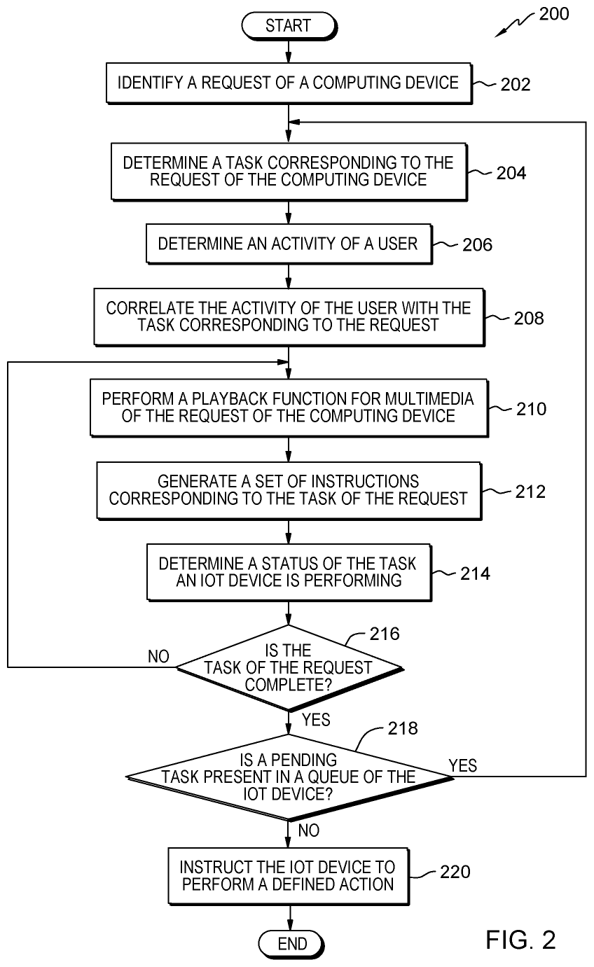

FIG. 2 is a flowchart depicting operational steps of request program 200, a program that performs playback functions of a multimedia feed based on a task of a request and a current user activity, in accordance with embodiments of the present invention. In one embodiment, request program 200 initiates in response to a user connecting client device 120 and IoT device(s) 130 to request program 200 through network 110. For example, request program 200 initiates in response to a user registering (e.g., opting-in) a chimney hob (e.g., client device 120) kitchen appliances (e.g., IoT device(s) 130) with request program 200 via a WLAN (e.g., network 110). In another embodiment, request program 200 is a background application that continuously monitors client device 120. For example, request program 200 is a client-side application (e.g., application 124) that initiates upon booting of a chimney hob (e.g., client device 120) of a user. In another example, request program 200 initiates upon request program 200 transmitting a video request to a video sharing application (e.g., application 124) of the chimney hob (e.g., client device 120).

In step 202, request program 200 identifies a request of a computing device. In one embodiment, request program 200 identifies a request from client device 120 for multimedia content of database 144. For example, request program 200 identifies a command (e.g., request, order, etc.) a server (e.g., server 140) receives that is associated with retrieval of a file (e.g., multimedia) from a database (e.g., database 144). In this example, request program 200 can identify the command based on a storage location of the database, which request program 200 may solely dedicate to multimedia (videos, audio, images, text, etc.) related to food.

In another embodiment, request program 200 utilizes user interface 122 to detect requests of application 124. For example, request program 200 monitors a touch screen (e.g., user interface 122) of a smart chimney (e.g., client device 120) of a hob to identify a user inputting an order related to food or a request for food preparation information (e.g., data file of database 144, etc.) that request program 200 displays on a video sharing application (e.g., application 124) of the smart chimney. In this example, request program 200 utilizes natural language processing (NLP) techniques (e.g., parsing, topic segmentation, natural language understanding, etc.) to determine whether an input selection of the user results in a command associated with a certain subject matter (e.g., food, recipes, etc.).

In step 204, request program 200 determines a task corresponding to the request of the computing device. In one embodiment, request program 200 identifies one or more tasks corresponding to a request of multimedia content of application 124. For example, request program 200 utilizes NLP (e.g., speech-to-text (STT), natural language understanding (NLU), speech recognition, etc.) techniques to identify an instruction (e.g., task) in the multimedia content a video sharing application (e.g., application 124) is displaying to a user. In this example, request program 200 identifies declarative statements in the multimedia content related to food preparation processes. Additionally, request program 200 identifies one or more IoT devices (e.g., IoT device(s) 130) associated with performance of the instruction. In an alternative example, request program correlates the declarative statements with textual data of a recipe file corresponding to an identified request.

In another example, request program 200 utilizes computer vision and NLP techniques to identify an instruction (e.g., task) in textual data shown in video of video sharing application (e.g., application 124). In this example, data files associated with an identified request are preloaded into a storage device of a smart chimney (e.g., client device 120), and request program 200 utilizes optical character recognition (OCR) to identify text in image of the video. Additionally, request program 200 utilizes machine encoded text from OCR to identify one or more instructions in images of the video.

In yet another example, request program 200 utilizes NLP techniques to identify an instruction (e.g., task) in audio data of video sharing application (e.g., application 124). In this example, request program 200 utilizes NLP techniques (e.g., speech to text (STT), automatic speech recognition, etc.) to identify one or more instructions related to food preparation processes in the audio data of the video sharing application. Additionally, request program 200 may utilize one or more sources data of the multimedia content available or the above-mentioned techniques to identify tasks.

In step 206, request program 200 determines an activity of a user. In various embodiments of the present invention request program 200 utilizes human activity recognition (HAR) to identify activities of a user. Generally, human activity recognition (HAR) is the ability to recognize/detect current activity on the basis of information received from different sensors, which can be cameras, wearable sensors, sensors attached to objects etc. Approaches for capturing human activities can be broadly classified into two groups (e.g., vision-based and sensor-based).

Additionally, human activities are grouped into four categories (e.g., Gesture, action, interaction, group activities) depending on body parts engaged in the action and complexity. Gestures are visible bodily actions representing a specific message, which is not a matter of verbal or vocal communication but rather a movement made with the hands, face, and/or other parts of the body such as “Okay” gestures and thumbs up. Actions are a set of physical movements conducted by only one person such as walking and running. Interactions are a set of actions executed by at most two actors where at least one subject is a person and the other one can be a human or an object (e.g., hand shaking, chatting, etc.). Group activities includes one or more of gestures, actions, or interactions, where the number of performers is at least two plus one or more interactive objects (playing volleyball, obstacle racing, etc.). Furthermore, request program 200 requires all users to opt-in to collection of activities and video monitoring prior to collecting or processing any personal data, content, or information the user wishes not to be processed.

In one embodiment, request program 200 identifies a current user activity of a user utilizing video of camera 126. For example, request program 200 utilizes HAR techniques to classify a current activity of a user within the field of view of an artificial intelligence (AI) camera (e.g., camera 126) of a smart chimney (e.g., client device 120) and/or one or more sensors of IoT enabled devices (e.g., IoT device(s) 130, wearable sensors, etc.) connected to the smart chimney. In this example, request program 200 feeds selected features of collected activity data corresponding to the user into a machine learning algorithm (e.g., Support Vector Machine (SVM), k-Nearest Neighbor (KNN), Random Forest (RF), Hidden Markov Model (HMM), Naive Bayes (NB), Decision Tree (DT), etc.) and infers a classification of a current user activity from an output of the machine learning algorithm. Additionally, request program 200 tracks user activity for a defined time-period (i.e., while video sharing application is active) to determine cooking progress of the user.

In step 208, request program 200 correlates the activity of the user with the task corresponding to the request. In one embodiment, request program 200 determines whether an identified task of multimedia of a request of application 124 corresponds to an identified current user activity of a user in video data of camera 126. For example, request program 200 identifies one or more tasks corresponding to one or more respective segments of multimedia content of video sharing application (e.g., application 124) of a smart chimney (e.g., client device 120). In this example, request program 200 compares an identified current user activity to an identified task of a current respective segment of the multimedia content and determines whether the identified current user activity correlates with the identified task (i.e., whether the activity of the user in the video data of the camera 126 matches the task of multimedia content segment of application 124).

In step 210, request program 200 performs a playback function for multimedia of the request of the computing device. In one embodiment, request program 200 initiates a playback function of application 124. For example, request program 200 utilizes video data of AI camera (e.g., camera 126) and metadata of multimedia content to control playback of the multimedia content. In this example, request program 200 identifies a time length and position of one or more segments of multimedia content that include an identified task that correlates to an identified current user activity. Additionally, request program 200 utilizes a present play time of the multimedia content on video sharing application (e.g., application 124) and the time length of a segment to identify an upcoming segment change. Also, request program 200 can initiate playback functions (e.g., pause, skip, rewind, fast forward, increase or slow playback speed, etc.) of the video sharing application based on whether correlated identified task and identified current user activity are a match. In addition, request program 200 can utilize segment positions, present play times, and segment time length to initiate playback functions.

In one scenario, if request program 200 determines that a first identified current user activity (e.g., using food processor) is not related to an identified task (e.g., sauté chopped produce), then request program 200 can execute a pause function of video sharing application (e.g., application 124) until request program 200 determines that a second current user activity (e.g., putting produce in skillet of stove) is related to the identified task. In another scenario, if request program 200 determines that a first identified current user activity (e.g., using food processor) that a user is currently engaged in is related to an identified task (e.g., chopping produce) and identifies a segment change (e.g., content related to a different task) in the multimedia content that includes an unrelated identified task, then request program 200 can execute a rewind function of video sharing application (e.g., application 124). In an example embodiment, if request program 200 determines that a IoT device(s) 130 starts performing a task correlated to a segment of a video of application 124, then request program 200 can determine whether to “pause” the video. Additionally, if determines that the IoT device(s) 130 stops performing the task correlated to the segment of the video of application 124, then request program 200 can determine whether to “play” the video.

In step 212, request program 200 generates a set of instructions corresponding to the task of the request. In one embodiment, request program 200 utilizes multimedia of application 124 to generate one or more sets of instructions for IoT device(s) 130. For example, request program 200 utilizes NLP techniques to generate a standard protocol to represent each IoT enabled device (e.g., IoT device(s) 130) and each task of requested multimedia content. In this example, request program 200 utilizes a client-side application (e.g., application 124, request program 200) of a smart chimney (e.g., client device 120) to generate a set of instructions corresponding to each task with respect to each IoT enabled device necessary to perform each task of the requested multimedia content. Additionally, the standard protocol allows each IoT enabled device to identify (i.e., understand) commands derived from the requested multimedia content as it relates to identified task. As a result, allowing any new IoT device that adheres to the new protocol can be integrated into the framework easily. In another embodiment, request program 200 schedules one or more tasks of one or more requests with an instance of IoT device(s) 130. For example, request program 200 can queue performance of two or more sets of instructions for an IoT device (e.g., IoT device(s) 130) based on availability/active status of the IoT device.

In an example embodiment, request program 200 generates a standard protocol to represent steps (e.g., task) in a recipe video (e.g., requested multimedia content). In one scenario, request program 200 determines the recipe requires a user to utilize a mixer (e.g., IoT device(s) 130) for fifteen (15) minutes followed by utilizing an oven (e.g., IoT device(s) 130) for two (2) hours and generates one or more sets of instructions to represent the two (2) tasks in a standard format. Additionally, request program 200 transmits the one or more sets of instructions to a video sharing application (e.g., application 124) of a smart chimney (e.g., client device 120) when the user initiates the recipe video. Also, request program 200 conditions (e.g., placing a jar in the mixer) in a set of instructions that automatically initiate performance of a task by IoT device(s) 130.

In step 214, request program 200 determine a status of the task an IoT device is performing. In one embodiment, request program 200 utilizes video of camera 126 to determine a status of a task IoT device(s) 130 and/or a user is performing. For example, request program 200 utilizes HAR techniques to identify interactions between a user and an object (e.g., knife, stove, IoT enabled appliance, etc.). In this example, request program 200 utilizes a live video feed of a smart camera (e.g., camera 126) to determine whether the user is engaged in a current user activity that correlates to a task of a set of instructions of multimedia content of a video sharing application (e.g., application 124) and updates task progress (e.g., cooking progress, instruction completion, etc.) based on a determined status (e.g., pending or complete) of the task.

In another embodiment, request program 200 communicates with IoT device(s) 130 to determine a status of a task. For example, request program 200 determines an activity status of an IoT device (e.g., IoT device(s) 130) identified in a set of instructions corresponding to a task of multimedia content of a video sharing application (e.g., application 124). In this example, request program 200 transmits a query to the IoT device to determine whether the IoT device is currently active. Additionally, request program 200 utilizes the response to the query to determine whether the activity of the IoT device is related to the set of instructions based on elements of a stack (e.g., storage device 142, memory 302, etc.) of the IoT device or IoT controlling server (e.g., server 140) to determine the task corresponding to the set of instructions.

In decision step 216, request program 200 determines whether the task of the request is complete. In one embodiment, request program 200 utilizes client device 120 to determine whether a task of IoT device(s) 130 is complete. For example, request program 200 utilizes task progress updates of a user as discussed in step 214 to determine whether a task related multimedia content is complete. In this example, request program 200 utilizes a determined status of the task progress updates to determine whether a task of an IoT device (e.g., IoT device(s) 130) is complete. In another example, request program 200 can determine whether a task related to a segment of multimedia content is complete by querying an IoT device (e.g., IoT device(s) 130) for activity status (e.g., running, sleep mode, etc.) and/or task information (e.g., pending, complete, etc.).

In another embodiment, if request program 200 determines that a task of IoT device(s) 130 is not complete (decision step 216, “NO” branch), then request program 200 initiates a playback function of application 124. For example, if request program 200 transmits a task information query to an IoT device (e.g., IoT device(s) 130) and determines the task status query is pending, then request program 200 can initiate playback functions to control playback of the multimedia content of a video sharing application (e.g., application 124).

In another embodiment, if request program 200 determines that a task of IoT device(s) 130 is complete (decision step 216, “YES” branch), then request program 200 determines whether IoT device(s) 130 is associated with a pending task. For example, if request program 200 transmits a task information query to an IoT device (e.g., IoT device(s) 130) and determines the task status query is complete, then request program 200 can determines whether a pending task is present in a queue of the IoT device as discussed below in step 218.

In decision step 218, request program 200 determines whether a pending task is present in a queue of the IoT device. In one embodiment, request program 200 utilizes client device 120 to determine whether IoT device(s) 130 is assigned a scheduled task. For example, request program 200 determines whether a queue of an IoT device (e.g., IoT device(s) 130) includes a set of instructions related to one or more task assigned future dated processing time. In this example, request program 200 queries the IoT device to determine whether the queue of the IoT device includes unprocessed sets of instructions that the IoT device is scheduled to process at future time.

In another embodiment, if request program 200 determines that IoT device(s) 130 is not assigned a scheduled task (decision step 218, “NO” branch), then request program 200 identifies another task corresponding to a request of multimedia content of application 124 as discussed in step 204. For example, if request program 200 transmits query to an IoT device (e.g., IoT device(s) 130) for scheduled unprocessed sets of instructions (e.g., pending task) and determines the queue of the IoT device includes no unprocessed sets of instructions, then request program 200 identify a task in the multimedia content a video sharing application (e.g., application 124) is displaying to a user.

In another embodiment, if request program 200 determines that is assigned a scheduled task (decision step 218, “YES” branch), then request program 200 initiates a defined action of IoT device(s) 130. For example, if request program 200 transmits query to an IoT device (e.g., IoT device(s) 130) for scheduled unprocessed sets of instructions (e.g., pending tasks) and determines the queue of the IoT device includes unprocessed sets of instructions, then request program 200 initiates performance of a defined action of the IoT device.

In step 220, request program 200 instructs the IoT device to perform a defined action. In one embodiment, request program 200 utilizes client device 120 to transmit a command to perform a defined action to IoT device(s) 130. For example, request program 200 can utilize a client-side application (e.g., application 124, request program 200) of a smart chimney to transmit commands (e.g., power off, sleep mode, etc.) to one or more IoT enabled devices (e.g., IoT device(s) 130). In this example, request program 200 can utilize the commands to conserve power consumption of the one or more IoT enabled devices, which reduces power consumption of a computing system (e.g., smart building) by powering off or activating a sleep mode of IoT devices with no pending tasks or that are not required in the performance of tasks of a request.

FIG. 3 depicts a block diagram of components of client device 120, IoT device(s) 130, and server 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

FIG. 3 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to client device 120, software and data 310 includes data of user interface 122, application 124, and camera 126. With respect to server 140, software and data 310 includes data of storage device 142 and request program 200.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, a task of multimedia of a video sharing application of a computing device;
determining, by one or more processors, an activity of a user utilizing a live video feed of a camera of the computing device;
determining, by one or more processors, whether the activity of the user correlates to the task of the multimedia; and
in response to determining that the activity of the user correlates to the task of the multimedia, initiating, by one or more processors, a playback function of the video sharing application of the computing device based at least in part on the activity of the user and the task of the multimedia.

2. The method of claim 1, further comprising:
generating, by one or more processors, a set of instructions corresponding to the task of the multimedia of the video sharing application of the computing device, wherein the set of instructions includes a standard protocol for commands between the computing device and one or more internet of things (IoT) enabled devices.

3. The method of claim 2, wherein generating the set of instructions corresponding to the task of the multimedia of the video sharing application of the computing device, further comprises:
identifying, by one or more processors, the one or more IoT enabled devices utilized to perform the task of the multimedia of the video sharing application of the computing device; and
generating, by one or more processors, a plurality of commands for the one or more IoT enabled devices that correspond to the task.

4. The method of claim 1, further comprising:
scheduling, by one or more processors, one or more tasks of the multimedia of the video sharing application of the computing device with one or more IoT enabled devices.

5. The method of claim 1, further comprising:
in response to determining that the task of the multimedia of the video sharing application of the computing device is complete, determining, by one or more processors, whether a queue of an IoT enable device is empty of pending tasks; and
instructing, by one or more processors, the IoT enabled device to perform a defined action to conserve power consumption.

6. The method of claim 1, wherein determining whether the activity of the user correlates to the task of the multimedia, further comprises:
comparing, by one or more processors, the task of the multimedia of the video sharing application of the computing device to the activity of the user, wherein the task corresponds to a current segment of the multimedia; and
determining, by one or more processors, whether the task of the multimedia of the video sharing application of the computing device and the activity of the user match.

7. The method of claim 1, wherein initiating the playback function of the video sharing application of the computing device based at least in part on the activity of the user and the task of the multimedia, further comprises:
identifying, by one or more processors, a segment change of the multimedia of the video sharing application, wherein the segment change corresponds to a portion of the multimedia that includes content related to a second task, wherein the content of the second task is unrelated to the content of the task;
determining, by one or more processors, a current playback position of the multimedia content of the video sharing application; and
initiating, by one or more processors, the playback function of the video sharing application that results in the activity of the user corresponding to a segment of the multimedia of the video sharing application that includes a matching task.

8. A computer program product comprising:
one or more computer readable storage media and program instructions stored on the one or more computer readable storage media, the program instructions comprising:
program instructions to identify a task of multimedia of a video sharing application of a computing device;
program instructions to determine an activity of a user utilizing a live video feed of a camera of the computing device;
program instructions to determine whether the activity of the user correlates to the task of the multimedia; and
in response to determining that the activity of the user correlates to the task of the multimedia, program instructions to initiate a playback function of the video sharing application of the computing device based at least in part on the activity of the user and the task of the multimedia.

9. The computer program product of claim 8, further comprising program instructions, stored on the one or more computer readable storage media, to:
generate a set of instructions corresponding to the task of the multimedia of the video sharing application of the computing device, wherein the set of instructions includes a standard protocol for commands between the computing device and one or more internet of things (IoT) enabled devices.

10. The computer program product of claim 9, wherein generating the set of instructions corresponding to the task of the multimedia of the video sharing application of the computing device, further comprise program instructions to:
identify the one or more IoT enabled devices utilized to perform the task of the multimedia of the video sharing application of the computing device; and
generate a plurality of commands for the one or more IoT enabled devices that correspond to the task.

11. The computer program product of claim 8, further comprising program instructions, stored on the one or more computer readable storage media, to:
schedule one or more tasks of the multimedia of the video sharing application of the computing device with one or more IoT enabled devices.

12. The computer program product of claim 8, further comprising program instructions, stored on the one or more computer readable storage media, to:
in response to determining that the task of the multimedia of the video sharing application of the computing device is complete, determine whether a queue of an IoT enable device is empty of pending tasks; and
instruct the IoT enabled device to perform a defined action to conserve power consumption.

13. The computer program product of claim 8, wherein determining whether the activity of the user correlates to the task of the multimedia, further comprise program instructions to:
compare the task of the multimedia of the video sharing application of the computing device to the activity of the user, wherein the task corresponds to a current segment of the multimedia; and
determine whether the task of the multimedia of the video sharing application of the computing device and the activity of the user match.

14. The computer program product of claim 8, wherein initiating the playback function of the video sharing application of the computing device based at least in part on the activity of the user and the task of the multimedia, further comprise program instructions to:
identify a segment change of the multimedia of the video sharing application, wherein the segment change corresponds to a portion of the multimedia that includes content related to a second task, wherein the content of the second task is unrelated to the content of the task;
determine a current playback position of the multimedia content of the video sharing application; and
initiate the playback function of the video sharing application that results in the activity of the user corresponding to a segment of the multimedia of the video sharing application that includes a matching task.

15. A computer system comprising:
one or more computer processors;
one or more computer readable storage media; and
program instructions stored on the computer readable storage media for execution by at least one of the one or more processors, the program instructions comprising:
program instructions to identify a task of multimedia of a video sharing application of a computing device;
program instructions to determine an activity of a user utilizing a live video feed of a camera of the computing device;
program instructions to determine whether the activity of the user correlates to the task of the multimedia; and
in response to determining that the activity of the user correlates to the task of the multimedia, program instructions to initiate a playback function of the video sharing application of the computing device based at least in part on the activity of the user and the task of the multimedia.

16. The computer system of claim 15, further comprising program instructions, stored on the one or more computer readable storage media for execution by at least one of the one or more processors, to:
generate a set of instructions corresponding to the task of the multimedia of the video sharing application of the computing device, wherein the set of instructions includes a standard protocol for commands between the computing device and one or more internet of things (IoT) enabled devices.

17. The computer system of claim 16, wherein generating the set of instructions corresponding to the task of the multimedia of the video sharing application of the computing device, further comprise program instructions to:
identify the one or more IoT enabled devices utilized to perform the task of the multimedia of the video sharing application of the computing device; and
generate a plurality of commands for the one or more IoT enabled devices that correspond to the task.

18. The computer system of claim 15, further comprising program instructions, stored on the one or more computer readable storage media for execution by at least one of the one or more processors, to:
schedule one or more tasks of the multimedia of the video sharing application of the computing device with one or more IoT enabled devices.

19. The computer system of claim 15, further comprising program instructions, stored on the one or more computer readable storage media for execution by at least one of the one or more processors, to:
in response to determining that the task of the multimedia of the video sharing application of the computing device is complete, determine whether a queue of an IoT enable device is empty of pending tasks; and
instruct the IoT enabled device to perform a defined action to conserve power consumption.

20. The computer system of claim 15, wherein initiating the playback function of the video sharing application of the computing device based at least in part on the activity of the user and the task of the multimedia, further comprise program instructions to:
identify a segment change of the multimedia of the video sharing application, wherein the segment change corresponds to a portion of the multimedia that includes content related to a second task, wherein the content of the second task is unrelated to the content of the task;
determine a current playback position of the multimedia content of the video sharing application; and
initiate the playback function of the video sharing application that results in the activity of the user corresponding to a segment of the multimedia of the video sharing application that includes a matching task.
